(19) United States
(12) Patent Application Publication
(10) Pub. No.: US 2026/0092131 A1
(43) Pub. Date: Apr. 2, 2026

(54) CATALYST COMPONENTS FOR THE POLYMERIZATION OF OLEFINS

(71) Applicant: Basell Poliolefine Italia S.r.l., Milano (IT)

(72) Inventors: Giuseppina Maria Algozzini, Ferrara (IT); Tiziana Caputo, Ferrara (IT); Gianni Collina, Ferrara (IT); Simone De Cicco, Ferrara (IT); Maria Di Diego, Ferrara (IT); Daniele Evangelisti, Ferrara (IT); Ofelia Fusco, Ferrara (IT); Benedetta Gaddi, Ferrara (IT); Piero Gessi, Ferrara (IT); Alberto Nardin, Ferrara (IT); Nicola Pazi, Ferrara (IT); Paolo Vincenzi, Ferrara (IT)

(73) Assignee: Basell Poliolefine Italia S.r.l., Milano (IT)

(21) Appl. No.: 19/114,962

(22) PCT Filed: Sep. 20, 2023
(86) PCT No.: PCT/EP2023/075891

§ 371 Date: Mar. 25, 2025

(30) Foreign Application Priority Data
Sep. 27, 2022 (EP) 22197919.8

(51) Int. Cl. C08F 4/655; B01J 35/40; B01J 35/61; B01J 35/63; C08F 4/656; C08F 110/00

(52) U.S. Cl. CPC C08F 4/655; B01J 35/40; B01J 35/615; B01J 35/633; B01J 35/635; B01J 35/638; C08F 4/656; C08F 110/00

(57) ABSTRACT

A solid catalyst component for the polymerization of olefins, made from or containing Ti, Mg and an internal donor selected from 1,3-diethers, wherein the solid catalyst component, has (i) an average particle size D50 ranging from 55 to 80 μm and (ii) a surface area (SA), determined with the BET method, such that the value of the formula SA×D50/100 is higher than 60.

### FIELD OF THE INVENTION

In general, the present disclosure relates to the field of chemistry. More specifically, the present disclosure relates to polymer chemistry. In particular, the present disclosure relates to diether based ZN catalyst components for use in the polymerization of olefins.

### BACKGROUND OF THE INVENTION

In some instances, gas-phase polymerization technology is used to produce polymers with a low investment cost. In some instances, diether based catalysts are used as alternatives to phthalate based catalysts.

In some instances, a gas-phase polymerization process forms polymer agglomerates, which build up in various places such as the polymerization reactor and the lines for recycling the gaseous stream. In some instances, agglomerates within the polymerization reactor disrupt the removal of polymer from the polymerization reactor by plugging the polymer discharge valves. In some instances, agglomerates fall and cover part of the reactor interior parts, thereby affecting adversely fluidization efficiency. In some instances, the formation of larger agglomerates leads to the shutdown of the reactor.

This problem is exacerbated in the presence of small catalyst particles, which may have a lower capability to dissipate polymerization heat. In some instances, larger catalyst particles yield polymer with poor morphology and lower bulk density.

### SUMMARY OF THE INVENTION

In a general embodiment, the present application provides a solid catalyst component for the polymerization of olefins, made from or containing Ti, Mg and an internal donor selected from 1,3-diethers, wherein the solid catalyst component has (i) an average particle size D50 ranging from 55 to 80 μm and (ii) a surface area (SA), determined with the BET method, such that the value of the formula SA×D50/100 is higher than 60, alternatively higher than 80, alternatively higher than 100, alternatively higher than 110.

### DETAILED DESCRIPTION OF THE INVENTION

In some embodiments, the solid catalyst component has an average particle size D50 ranging from 55 to 75 μm, alternatively from 55 to 70 μm, alternatively from 58 to 70 μm.

In some embodiments, the catalyst component has a porosity (P), measured by the BET method, higher than 0.18 cm³/g, alternatively higher than 0.19 cm³/g, alternatively ranging from 0.20 to 0.25 cm³/g.

In some embodiments, the surface area (SA) ranges from 180 to 400 m²/g, alternatively from 200 to 350 m²/g.

In some embodiments, the value of the formula SA×P is higher than 10, alternatively higher than 20, alternatively higher than 25, alternatively higher than 40.

In some embodiments, the above features are referred to the solid catalyst component in its non-prepolymerized form.

In some embodiments, the internal donor is selected from 1,3-diethers of formula (I)

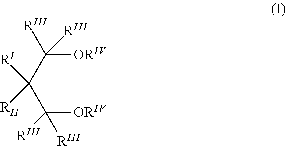

wherein R^{I} and R^{II} are the same or different and are hydrogen or linear or branched C₁-C₁₈ hydrocarbon groups; R^{III} groups, equal or different from each other, are hydrogen or C₁-C₁₈ hydrocarbon groups; R^{IV} groups, equal or different from each other, have the same meaning of R^{III} except that R^{IV} groups are not hydrogen. In some embodiments, R^{I} or R^{II} has constituents which form cyclic structures. In some embodiments, each of R^{I} to R^{IV} groups contain heteroatoms selected from the group consisting of halogens, N, O, S and Si.

In some embodiments, R^{IV} is a 1-6 carbon atom alkyl radical, alternatively a methyl. In some embodiments, the R^{III} radicals are hydrogen. In some embodiments, R^{I} is selected from the group consisting of methyl, ethyl, propyl, and isopropyl while R^{II} is selected from the group consisting of ethyl, propyl, isopropyl, butyl, isobutyl, tert-butyl, isopentyl, 2-ethylhexyl, cyclopentyl, cyclohexyl, methylcyclohexyl, phenyl, and benzyl. In some embodiments, R^{I} is hydrogen while R^{II} is selected from the group consisting of ethyl, butyl, sec-butyl, tert-butyl, 2-ethylhexyl, cyclohexylethyl, diphenylmethyl, p-chlorophenyl, 1-naphthyl, and 1-decahydronaphthyl. In some embodiments, R^{I} and R^{II} are the same and selected from the group consisting of ethyl, propyl, isopropyl, butyl, isobutyl, tert-butyl, neopentyl, phenyl, benzyl, cyclohexyl, and cyclopentyl.

In some embodiments, the 1,3-diethers are selected from the group consisting of 2-(2-ethylhexyl) 1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2-(2-cyclohexylethyl)-1,3-dimethoxypropane, 2-(p-chlorophenyl)-1,3-dimethoxypropane, 2-(diphenylmethyl)-1,3-dimethoxypropane, 2 (1-naphthyl)-1,3-dimethoxypropane, 2 (p-fluorophenyl)-1,3-dimethoxypropane, 2 (1-decahydronaphthyl)-1,3-dimethoxypropane, 2 (p-tert-butylphenyl)-1,3-dimethoxypropane, 2,2-dicyclohexyl-1,3-dimethoxypropane, 2,2-diethyl-1,3-dimethoxypropane, 2,2-dipropyl-1,3-dimethoxypropane, 2,2-dibutyl-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2-methyl-2-phenyl-1,3-dimethoxypropane, 2-methyl-2-cyclohexyl-1,3-dimethoxypropane, 2-methyl-2-methylcyclohexyl-1,3-dimethoxypropane, 2,2-bis(p-chlorophenyl)-1,3-dimethoxypropane, 2,2-bis(2-phenylethyl)-1,3-dimethoxypropane, 2,2-bis(2-cyclohexylethyl)-1,3-dimethoxypropane, 2-methyl-2-isobutyl-1,3-dimethoxypropane, 2-methyl-2-(2-ethylhexyl)-1,3-dimethoxypropane, 2,2-bis(2-ethylhexyl)-1,3-dimethoxypropane, 2,2-bis(p-methylphenyl)-1,3-dimethoxypropane, 2-methyl-2-isopropyl-1,3-dimethoxypropane, 2,2-diisobutyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 2-isobutyl-2-isopropyl-1,3-dimetoxypropane, 2,2-di-sec-butyl-1,3-dimetoxypropane, 2,2-di-tert-butyl-1,3-dimethoxypropane, 2,2-dineopentyl-1,3-dimethoxypropane, 2-iso-propyl-2-isopentyl-1,3-dimethoxypropane, 2-phenyl-2-benzyl-1,3-dimetoxypropane, 2-cyclohexyl-2-cyclohexylmethyl-1,3-dimethoxypropane, and 2-cyclohexyl-2-i-pentyl-1,3-dimethoxypropane.

In some embodiments, the 1,3-diethers have formula (II)

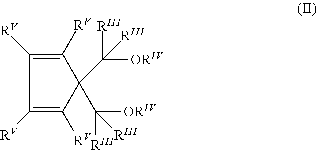

wherein the radicals R^{IV} have the same meaning defined in formula (I) and the radicals R^{III} and R^{V}, equal or different to each other, are selected from the group consisting of hydrogen; halogens; C₁-C₂₀ alkyl radicals, linear or branched; C₃-C₂₀ cycloalkyl, C₆-C₂₀ aryl, C₇-C₂₀ alkylaryl, and C₇-C₂₀ arylalkyl radicals. In some embodiments, two or more of the R^{V} radicals are bonded to each other to form condensed cyclic structures, saturated or unsaturated, optionally substituted with R^{VI} radicals. In some embodiments, R^{VI} radicals are selected from the group consisting of halogens; C₁-C₂₀ alkyl radicals, linear or branched; C₃-C₂₀ cycloalkyl, C₆-C₂₀ aryl, C₇-C₂₀ alkylaryl and C₇-C₂₀ arylalkyl radicals. In some embodiments, the halogens are selected from the group consisting of Cl and F. In some embodiments, the radicals R^{V} and R^{VI} contain one or more heteroatoms as substitutes for carbon or hydrogen atoms, or both.

In some embodiments and in the 1,3-diethers of formulae (I) and (II), the R^{III} radicals are hydrogen, and the R^{IV} radicals are methyl. In some embodiments, the 1,3-diethers of formula (II) have two or more of the R^{V} radicals bonded to each other, thereby forming one or more condensed cyclic structures, optionally substituted by R^{VI} radicals. In some embodiments, the condensed cyclic structures are benzenic. In some embodiments, the 1,3-diethers have formula (III):

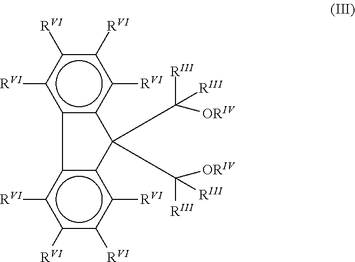

wherein the R^{III} and R^{IV} radicals have the same meaning defined in formula (I), R^{VI} radicals, equal or different, are hydrogen; halogens; C₁-C₂₀ alkyl radicals, linear or branched; C₃-C₂₀ cycloalkyl, C₆-C₂₀ aryl, C₇-C₂₀ alkylaryl, and C₇-C₂₀ aralkyl radicals, optionally containing one or more heteroatoms selected from the group consisting of N, O, S, P, Si and halogens, as substitutes for carbon or hydrogen atoms, or both. In some embodiments, the halogens are selected from the group consisting of Cl and F.

In some embodiments, the 1,3-diethers of formulae (II) and (III) are selected from the group consisting of:
1,1-bis(methoxymethyl)-cyclopentadiene;
1,1-bis(methoxymethyl)-2,3,4,5-tetramethylcyclopentadiene;
1,1-bis(methoxymethyl)-2,3,4,5-tetraphenylcyclopentadiene;
1,1-bis(methoxymethyl)-2,3,4,5-tetrafluorocyclopentadiene;
1,1-bis(methoxymethyl)-3,4-dicyclopentylcyclopentadiene;
1,1-bis(methoxymethyl) indene; 1,1-bis(methoxymethyl)-2,3-dimethylindene;
1,1-bis(methoxymethyl)-4,5,6,7-tetrahydroindene;
1,1-bis(methoxymethyl)-2,3,6,7-tetrafluoroindene;
1,1-bis(methoxymethyl)-4,7-dimethylindene;
1,1-bis(methoxymethyl)-3,6-dimethylindene;
1,1-bis(methoxymethyl)-4-phenylindene;
1,1-bis(methoxymethyl)-4-phenyl-2-methylindene;
1,1-bis(methoxymethyl)-4-cyclohexylindene;
1,1-bis(methoxymethyl)-7-(3,3,3-trifluoropropyl) indene;
1,1-bis(methoxymethyl)-7-trimethyisilylindene;
1,1-bis(methoxymethyl)-7-trifluoromethylindene;
1,1-bis(methoxymethyl)-4,7-dimethyl-4,5,6,7-tetrahydroindene;
1,1-bis(methoxymethyl)-7-methylindene;
1,1-bis(methoxymethyl)-7-cyclopenthylindene;
1,1-bis(methoxymethyl)-7-isopropylindene;
1,1-bis(methoxymethyl)-7-cyclohexylindene;
1,1-bis(methoxymethyl)-7-tert-butylindene;
1,1-bis(methoxymethyl)-7-tert-butyl-2-methylindene;
1,1-bis(methoxymethyl)-7-phenylindene;
1,1-bis(methoxymethyl)-2-phenylindene;
1,1-bis(methoxymethyl)-1H-benz[e]indene;
1,1-bis(methoxymethyl)-1H-2-methylbenz[e]indene;
9,9-bis(methoxymethyl) fluorene;
9,9-bis(methoxymethyl)-2,3,6,7-tetramethylfluorene;
9,9-bis(methoxymethyl)-2,3,4,5,6,7-hexafluorofluorene;
9,9-bis(methoxymethyl)-2,3-benzofluorene;
9,9-bis(methoxymethyl)-2,3,6,7-dibenzofluorene;
9,9-bis(methoxymethyl)-2,7-diisopropylfluorene;
9,9-bis(methoxymethyl)-1,8-dichlorofluorene;
9,9-bis(methoxymethyl)-2,7-dicyclopentylfluorene;
9,9-bis(methoxymethyl)-1,8-difluorofluorene;
9,9-bis(methoxymethyl)-1,2,3,4-tetrahydrofluorene;
9,9-bis(methoxymethyl)-1,2,3,4,5,6,7,8-octahydrofluorene; and
9,9-bis(methoxymethyl)-4-tert-butylfluorene.

In some embodiments, additional electron donors different from diethers are present in a minor amount. In some embodiments, the additional donors are selected from alcohols or mono carboxylic acid esters. In some embodiments, the molar amount of the additional donors is less than 25% of the amount of 1,3-diethers.

In some embodiments, the molar ratio between the 1,3-diether and the Ti atoms in the final solid catalyst component ranges from 0.3:1 to 1.5:1, alternatively from 0.4:1 to 1.3:1.

In some embodiments, the molar ratio between the Mg atoms and the 1,3-diether in the final solid catalyst component ranges from 4.0:1 to 25.0:1, alternatively from 5.0:1 to 20.0:1.

In some embodiments, the Mg/Ti molar ratio ranges from 2 to 25, alternatively from 4 to 20, alternatively ranging from 5 to 10.

In some embodiments, the solid catalyst component is made from or containing the electron donors, a titanium compound having a Ti-halogen bond, and a Mg halide. In some embodiments, the magnesium halide is MgCl₂ in active form as a support for Ziegler-Natta catalysts. In some embodiments, the magnesium dihalides in active form used as support or co-support in components of catalysts for the polymerization of olefins have X-ray spectra wherein the most intense diffraction line that appears in the spectrum of the non-active halide is diminished in intensity and is replaced by a halo whose maximum intensity is displaced towards lower angles relative to that of the more intense line.

In some embodiments, the titanium compounds are selected from the group consisting of TiCl₄ and TiCl₃. In some embodiments, the titanium compounds are Ti-haloalcoholates having formula Ti(OR)_{n-y}X_{y}, where n is the valence of titanium, y is a number between 1 and n−1, X is halogen, and R is a hydrocarbon radical having from 1 to 10 carbon atoms.

In some embodiments, the solid catalyst component is prepared by reacting a titanium compound of formula Ti(OR⁵)_{m-y}X_{y}, where m is the valence of titanium and y is a number between 1 and m, with a magnesium chloride deriving from an adduct of formula MgCl₂·pR⁶OH, where p is a number between 1.5 and 4.5, and R⁶ is a hydrocarbon radical having 1-18 carbon atoms. In some embodiments, the titanium compound is TiCl₄. In some embodiments, an adduct between magnesium chloride and alcohol containing from 1.5 to 4.0 moles of alcohol per mole of Mg is used. In some embodiments, the alcohol is ethanol.

In some embodiments, the adduct is prepared by contacting MgCl₂ and alcohol in the absence of the inert liquid dispersant, heating the system at the melting temperature of MgCl₂-alcohol adduct or above, and maintaining the conditions, thereby providing a melted adduct. In some embodiments, the adduct is kept at a temperature equal to or higher than the adduct's melting temperature, under stirring conditions, for a time period equal to, or greater than, 1 hour, alternatively from 2 to 15 hours, alternatively from 5 to 10 hours. The molten adduct is then emulsified in a liquid medium, which is immiscible with and chemically inert to the adduct, and finally quenched by contacting the adduct with an inert cooling liquid, thereby solidifying the adduct. In some embodiments and before recovering the solid particles, the solid particles are left in the cooling liquid at a temperature ranging from −10 to 25° C. for a time ranging from 1 to 24 hours.

In some embodiments, MgCl₂ particles are dispersed in an inert liquid immiscible with and chemically inert to the molten adduct, the system is heated at temperature equal to or higher than the melting temperature of MgCl₂·ethanol adduct, and then alcohol is added in vapor phase. The temperature is kept at values such that the adduct is melted for a time ranging from 10 minutes to 10 hours. The molten adduct is then treated as described above. In some embodiments, the liquid in which the MgCl₂ is dispersed, or the adduct emulsified, is a liquid immiscible with and chemically inert to the molten adduct. In some embodiments, the liquid is aliphatic, aromatic or cycloaliphatic hydrocarbons or silicone oils. In some embodiments, the liquids are aliphatic hydrocarbons. In some embodiments, the liquid is vaseline oil.

In some embodiments, the quenching liquid is selected from hydrocarbons that are liquid at temperatures ranging from −30 to 30° C. In some embodiments, the quenching liquids are pentane, hexane, heptane or mixtures thereof.

In some embodiments, the particle size of the final adduct is obtained by setting the fluid dynamic parameters (Reynolds number, type of rotor stator systems, or other parameters) governing the formation of adduct droplet size, which are in relation to the size of the solid particles. In some embodiments, the parameters are as described in Patent Cooperation Treaty Publication No. WO02/051544, alternatively Patent Cooperation Treaty Publication No. WO02/051544, pages 6-7.

In some embodiments, the resulting adduct contains from 3 to 4.5 mols of ethanol per mole of Mg.

In some embodiments, the porosity of the solidified adduct particles is increased by a dealcoholation step. In some embodiments, the dealcoholation step is as described in European Patent Application No. EP-A-395083, wherein dealcoholation is obtained by keeping the adduct particles in a fluidized bed created by the flowing of warm nitrogen which after removal of the alcohol from the adduct particles is directed out of the system. In some embodiments, the dealcoholation treatment is carried out at increasing temperature gradient until the particles have reached the alcohol content. In some embodiments, the resulting alcohol content is at least 10% (molar amount) lower than the initial amount.

In some embodiments, the dealcoholation treatment is carried out until moles of alcohol per mole of Mg range from 1.5 to less than 3.5, alternatively from 1.5 to 3.0.

In some embodiments, the reaction with the Ti compound is carried out by suspending the adduct (dealcoholated or as such) in TiCl₄ at a temperature of 0° C. or below, alternatively ranging from −2° C. to −15° C., alternatively from −3° C. to −10° C. In some embodiments, the adduct is used in an amount providing a concentration ranging from 20 to 80 g/l, alternatively from 30 to 60 g/l, alternatively from 35 to less than 55 g/1. In some embodiments, the electron donor (I) is added to the system at the beginning of this stage of reaction. In some embodiments, the electron donor (I) is added to the system when the temperature of the mixture is in the range of 10° C. to 60° C. In some embodiments, the electron donor (I) is fed in amounts providing the molar ratio in the final catalyst. In some embodiments, the Mg/donor (I) molar ratio ranges from 2:1 to 15:1, alternatively from 3:1 to 10:1. The temperature is then gradually raised up until reaching a temperature ranging from 90-130° C. and kept at this temperature for 0.5-3 hours.

After completing the reaction time, stirring is stopped. The slurry is allowed to settle. The liquid phase is removed. A second stage of treatment with TiCl₄ is performed. In some embodiments, the second stage of treatment with TiCl₄ is carried out at a temperature ranging from 70 to 130° C. After completing the reaction time, stirring is stopped. The slurry is allowed to settle. The liquid phase is removed. In some embodiments, an additional reaction stage with the titanium compound is carried out. In some embodiments, the additional reaction stage is carried out with TiCl₄ under the same conditions described above and in the absence of electron donors. In some embodiments, the resulting solid is washed with liquid hydrocarbon under mild conditions and then dried.

In some embodiments, the solid catalyst component contains additional metal compounds made from or containing elements belonging to group 1-15, alternatively groups 11-15, of the periodic table of elements (IUPAC version).

In some embodiments, the compounds include elements selected from Cu, Zn, and Bi not containing metal-carbon bonds. In some embodiments, the compounds are the oxides, carbonates, alkoxylates, carboxylates and halides of the metals. In some embodiments, the compounds are selected from the group consisting of ZnO, ZnCl₂, CuO, CuCl₂, Cu diacetate, BiCl₃, Bi carbonates, and Bi carboxylates. In some embodiments, the compounds are selected from the group consisting of BiCl₃, Bi carbonates and Bi carboxylates.

In some embodiments, the compounds are added during the preparation of the magnesium-alcohol adduct. In some embodiments, the compounds are introduced into the catalysts by dispersing the compounds into the titanium compound in liquid form which is then reacted with the adduct.

In some embodiments, the final amount of the metals into the final catalyst component ranges from 0.1 to 10% wt, alternatively from 0.3 to 8% wt, alternatively from 0.5 to 5% wt, with respect to the total weight of solid catalyst component.

In some embodiments, the solid catalyst components are used in the polymerization of olefins by reacting the components with organoaluminum compounds.

In some embodiments, the present disclosure provides a catalyst for the polymerization of olefins CH₂═CHR, wherein R is hydrogen or a C₁-C₁₂ hydrocarbyl radical made from or containing the product of the reaction between:
(i) the solid catalyst component and
(ii) an alkylaluminum compound and, optionally,
(iii) an external electron donor compound.

In some embodiments, the alkyl-Al compound (ii) is a trialkyl aluminum compound. In some embodiments, the trialkyl aluminum compound is selected from the group consisting of triethylaluminum, tri-n-hexylaluminum, and tri-n-octylaluminum. In some embodiments, the alkyl-Al compound (ii) is a mixture of trialkylaluminums with alkylaluminum halides, alkylaluminum hydrides or alkylaluminum sesquichlorides. In some embodiments, the alkylaluminum sesquichloride is AlEt₂Cl or Al₂Et₃Cl₃.

In some embodiments, the aluminum alkyl compound is used in the gas-phase process in amount such that the Al/Ti molar ratio ranges from 10 to 400, alternatively from 30 to 250, alternatively from 40 to 200.

In some embodiments, the catalyst system includes external electron-donors (ED) selected from the group consisting of ethers, esters, heterocyclic compounds, and silicon compounds. In some embodiments, the ethers are the 1,3 diethers previously described as internal donors in the solid catalyst component (a). In some embodiments, the esters are esters of aliphatic saturated mono or dicarboxylic acids. In some embodiments, the esters are selected from the group consisting of malonates, succinates and glutarates. In some embodiments, the heterocyclic compound is 2,2,6,6-tetramethyl piperidine. In some embodiments, the silicon compounds have at least a Si—O—C bond. In some embodiments, the silicon compounds have formula Ra⁵Rb⁶Si(OR⁷)c, where a and b are integer from 0 to 2, c is an integer from 1 to 3 and the sum (a+b+c) is 4; R⁵, R⁶, and R⁷ are alkyl, cycloalkyl or aryl radicals with 1-18 carbon atoms optionally containing heteroatoms selected from N, O, halogen and P. In some embodiments, the silicon compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane, and 1,1,1,trifluoropropyl-methyldimethoxysilane. In some embodiments, the external electron donor compound is used in an amount to give a molar ratio between the organo-aluminum compound and the electron donor compound of from 2 to 500, alternatively from 5 to 350, alternatively from 7 to 200, alternatively from 7 to 150.

In some embodiments, the solid catalyst component for direct use in polymerization together with the co-catalyst. In some embodiments, the solid catalyst component is subjected to pre-polymerization conditions in the presence of the olefin monomer and an Al-alkyl compound.

As used herein, the term “pre-polymerization conditions” refers to the complex of temperature, monomer feeding, and amount of reagents, for preparing a pre-polymerized catalyst component, containing from 0.1 to 500 g of polymer per g of catalysts.

In some embodiments, the co-catalyst used in the prepolymerization is the same alkyl-Al compound (ii).

In some embodiments, the prepolymerization is carried out either in-line, that is, in one of the reactors of a cascade polymerization process, or batchwise. In some embodiments and in the batch process, the final pre-polymerized catalyst is recovered, isolated and then used in a separate polymerization process.

In some embodiments and in the batch pre-polymerization, low amounts of alkyl-Al compound are used. In some embodiments, the amount provides an Al compound/catalyst weight ratio from ranging from 0.001 to 10, alternatively from 0.005 to 5, alternatively from 0.005 to 1.5.

In some embodiments, the pre-polymerization is carried out with an α-olefins. In some embodiments, the α-olefin is selected from the group consisting of ethylene, propylene, butene-1,4-methyl-penyene-1, hexene-1 and octene-1.

In some embodiments, the pre-polymerization step is carried out at temperatures from 0° to 80° C., alternatively from 5° to 50° C., in liquid or gas-phase. In some embodiments, the batch pre-polymerization of the catalyst is with ethylene, thereby producing an amount of polymer ranging from 0.5 to 20 g per gram of catalyst component.

In some embodiments, the external donor is selected from the group consisting of silicon compounds, ethers, esters, amines, heterocyclic compounds, and ketones. In some embodiments, the ethers are 1,3-diethers of formula (I). In some embodiments, the pre-polymerization is achieved in the absence of an external donor.

In some embodiments, the pre-polymerization is carried out in liquid phase, (slurry or bulk) or in gas-phase. In some embodiments, the pre-polymerization occurs at temperatures ranging from −20 to 80° C., alternatively from 0° C. to 75° C. In some embodiments, the pre-polymerization is carried out in a liquid diluent, alternatively liquid light hydrocarbons. In some embodiments, the liquid light hydrocarbons are selected from the group consisting of pentane, hexane and heptane. In some embodiments, the pre-polymerization is carried out in a more viscous medium. In some embodiments, the medium has a kinematic viscosity ranging from 5 to 100 cSt at 40° C. In some embodiments, the medium is a pure substance or a homogeneous mixture of substances having different kinematic viscosity. In some embodiments, the medium is a hydrocarbon medium. In some embodiments, the medium has a kinematic viscosity ranging from 10 to 90 cSt at 40° C.

In some embodiments, the olefin monomer to be pre-polymerized is fed in a predetermined amount and in one step in the reactor before the pre-polymerization. In some embodiments, the olefin monomer is continuously supplied to the reactor during polymerization.

In some embodiments, the catalysts are for use in a polymerization, alternatively for gas-phase polymerization. In some embodiments, the present disclosure provides a gas-phase process for the polymerization of olefins CH₂═CHR, wherein R is hydrogen or a C₁-C₁₂ hydrocarbyl group, carried out in the presence of the catalyst system. In some embodiments, the gas-phase process is carried out with a gas-phase reactor. In some embodiments, the gas-phase process is carried out operating in one or more fluidized or mechanically agitated bed reactors. In some embodiments and in the fluidized bed reactors, the fluidization is obtained by a stream of inert fluidization gas, wherein the velocity of which is not higher than transport velocity. In some embodiments, the bed of fluidized particles is in a more or less confined zone of the reactor. In some embodiments and in the mechanically agitated bed reactor, the polymer bed is kept in place by the gas flow generated by the continuous blade movement, wherein the regulation determines the height of the bed. In some embodiments, the operating temperature is between 5° and 85° C., alternatively between 6° and 85° C. In some embodiments, the operating pressure ranges from 0.5 and 8 MPa, alternatively between 1 and 5 MPa, alternatively between 1.0 and 3.0 MPa. In some embodiments, inert fluidization gases dissipate the heat generated by the polymerization reaction. In some embodiments, the inert fluidization gases are selected from nitrogen and saturated light hydrocarbons. In some embodiments, the saturated light hydrocarbons are selected from the group consisting of propane, pentane, hexane, and mixture thereof.

In some embodiments, the polymer molecular weight is controlled by using hydrogen or another molecular weight regulator such as ZnEt₂. In some embodiments, hydrogen is used, the hydrogen/propylene molar ratio from 0.0002 and 0.5, and the propylene monomer is from 20% to 100% by volume, alternatively from 30 to 70% by volume, based on the total volume of the gases present in the reactor. In some embodiments, the remaining portion of the feeding mixture is made from or containing inert gases or one or more α-olefin comonomers.

In some embodiments, the catalyst is used in gas-phase polymerization technology including at least two interconnected polymerization zones. The process is carried out in a first interconnected polymerization zone and a second interconnected polymerization zone, to which propylene and ethylene or propylene and alpha-olefins are fed in the presence of a catalyst system and from which the polymer produced is discharged. In some embodiments, the growing polymer particles flow through the first of polymerization zone (riser) under fast fluidization conditions, leave the first polymerization zone, enter the second polymerization zone (downcomer) through which the polymer particles flow in a densified form under the action of gravity, leave the second polymerization zone, and are reintroduced into the first polymerization zone, thereby establishing a circulation of polymer between the two polymerization zones. In some embodiments, the conditions of fast fluidization in the first polymerization zone are established by feeding the monomers gas mixture below the point of reintroduction of the growing polymer into the first polymerization zone. In some embodiments, the velocity of the transport gas into the first polymerization zone is higher than the transport velocity under the operating conditions, alternatively between 2 and 15 m/s. In the second polymerization zone, where the polymer flows in densified form under the action of gravity, high values of density of the solid are reached which approach the bulk density of the polymer. In some embodiments, a positive gain in pressure is obtained along the direction of flow, thereby permitting reintroduction of the polymer into the first reaction zone without the help of mechanical devices. In this way, a “loop” circulation is set up, which is defined by the balance of pressures between the two polymerization zones and by the head loss introduced into the system. In some embodiments, one or more inert gases, such as nitrogen or an aliphatic hydrocarbon, are maintained in the polymerization zones, in quantities such that the sum of the partial pressures of the inert gases is between 5 and 80% of the total pressure of the gases. In some embodiments, the operating temperature ranges from 50 and 85° C., alternatively between 6° and 85° C. In some embodiments, the operating pressure ranges from 0.5 to 10 MPa, alternatively between 1.5 and 6 MPa. In some embodiments, the catalyst components are fed to the first polymerization zone, at a point of the first polymerization zone. In some embodiments, the catalyst components are fed at a point of the second polymerization zone. In some embodiments, the use of molecular weight regulator is carried out under the previously described conditions. In some embodiments and as described in Patent Cooperation Treaty Publication No. WO00/02929, the gas mixture present in the riser is prevented or partially prevented from entering the downcomer. In some embodiments, a gas and/or liquid mixture having a composition different from the gas mixture present in the riser is introduced in the downcomer, thereby preventing or partially preventing the gas mixture in the riser from entering the downcomer. In some embodiments, the two interconnected polymerization zones have different monomer compositions, thereby producing polymers with different properties.

In some embodiments, the catalyst provides a low delta temperature between the reactor wall and the reactor interior. In some embodiments, the catalyst components are for producing propylene polymers, such as homo, raco and heterophasic copolymers, with high bulk density, alternatively over 0.40 g/cm³, alternatively over 0.42 g/cm³. In some embodiments, the Melt Flow Rate of the polymer produced ranges from 0.1 to 100 g/10′, alternatively from 1 to 70 g/10′.

### EXAMPLES

The following examples are given to illustrate the disclosure without limiting the disclosure.

### Characterization

### Determination of X.I.

2.5 g of polymer were dissolved in 250 ml of o-xylene under stirring at 135° C. for 30 minutes. The solution was cooled to 25° C. After 30 minutes, the insoluble polymer was filtered. The resulting solution was evaporated in nitrogen flow. The residue was dried and weighed to determine the percentage of soluble polymer and then, by difference, the X.I. %.

### Average Particle Size of the Adduct and Catalysts

Determined by a method based on the principle of the optical diffraction of monochromatic laser light with the “Malvern Instr. 2600” apparatus. The average size is given as D50, being defined as the value of the diameter such that 50% of the total volume of particles have a diameter lower than that value.

Bulk Density ASTM D 1895/96 Method A

Melt flow rate (MFR) determined according to ISO 1133 (230° C., 2.16 Kg)

Porosity and Surface Area with Nitrogen

Porosity and surface area with nitrogen were determined according to the B.E.T. method (apparatus used SORPTOMATIC 1900 by Carlo Erba).

Porosity and Surface Area with Mercury:

The measurement was carried out using a “Porosimeter 2000 Series” by Carlo Erba. The porosity was determined by absorption of mercury under pressure. For this determination, a calibrated dilatometer (diameter 3 mm) CD3 (Carlo Erba) was connected to a reservoir of mercury and to a high-vacuum pump (1·10-2 mbar). A weighed amount of sample was placed in the dilatometer. The apparatus was then placed under high vacuum (<0.1 mm Hg) and maintained in these conditions for 20 minutes. The dilatometer was then connected to the mercury reservoir. The mercury was allowed to flow into the dilatomer until the mercury reached the level marked on the dilatometer at a height of 10 cm. The valve that connected the dilatometer to the vacuum pump was closed. The mercury pressure was gradually increased with nitrogen up to 140 kg/cm². Under the effect of the pressure, the mercury entered the pores. The level went down according to the porosity of the material.

The porosity (cm³/g), due to pores up to 1 μm for catalysts (10 μm for polymers), the pore distribution curve, and the average pore size were directly calculated from the integral pore distribution curve, which was function of the volume reduction of the mercury and applied pressure values (these data were provided and elaborated by the porosimeter associated computer which is equipped with a “MILESTONE 200/2.04” program by C. Erba.

### Procedure for Propylene Polymerization Test

The propylene copolymer compositions of the examples were prepared in a single gas-phase polymerization reactor having two interconnected polymerization zones, a riser and a downcomer, as described in the section general polymerization procedure of Patent Cooperation Treaty Publication No. WO00/02929, with the difference that the barrier feed was not implemented. With the aim of measuring the difference in temperature between wall temperature and reactor interior during the transitions, the reactor was equipped with a couple of thermal probes located at the bottom of the downcomer. Triethylaluminium (TEAL) was used as co-catalyst and dicyclopentyldimethoxysilane as external donor, with the weight ratios indicated in the examples. Starting from operative conditions for producing a specific polymer grade indicated in each example, a transition to a different polymer grade was carried out by changing polymerization conditions. During transition time, the delta temperature between reactor wall and reactor interior was measured as an evaluation of smooth operability.

### EXAMPLES

### Example 1

### Catalyst Support

In a vessel reactor, equipped with an IKA RE 166 stirrer, containing 183.5 g of anhydrous EtOH at −8° C., and under stirring, 100 g of MgCl₂ and 3.2 g of water were introduced. After the MgCl₂ was added, the temperature was raised up to 108° C. and maintained for 20 hrs. Next and while maintaining the temperature at 108° C., the melt was fed by volumetric pump set to 260 ml/min together with OB55 oil fed by volumetric pump set to 1100 ml/min, to an emulsification unit operating at 1500 rpm and producing an emulsion of the melt into the oil. While melt and oil were fed in continuous, the mixture at about 108° C. was continuously discharged into a vessel containing 5 liters of cold hexane, which was kept under stirring and cooled, thereby ensuring that the final temperature did not exceed 12° C. After 24 hours, the solid particles of the adduct recovered were then washed with hexane and dried at 40° C. under vacuum. The particles had a D50 diameter of 68.6 μm. The adduct was then thermally dealcoholated in a fluidized bed under increasing temperature nitrogen flow until the content of EtOH reached a chemical composition of 50.2% wt EtOH, 1.4% wt H₂O, and the remaining being MgCl₂.

### Preparation of Final Catalyst Component

Into a 2.0 liter round bottom flask, equipped with mechanical stirrer, cooler and thermometer, 1.0 l of TiCl₄ were introduced at room temperature under nitrogen atmosphere. After cooling at −5° C., while stirring, 54 g of microspheroidal prepared as described above were introduced. The temperature was then raised from −5° C. up to 40° C. at a speed of 0.3° C./min. An amount of 9,9-bis(methoxymethyl) fluorene, for providing a Mg/diether molar ratio of 8, was added. The temperature was raised to 100° C. for 50 min. The treatment with TiCl₄ was repeated at 110° C. for 50 min with additional Mg/diether molar ratio of 21 (total 5.8 m.r.), and then at 110° C. for additional 30′. The solid was then washed five times with anhydrous hexane (5×900 ml) at 60° C.

The solid was finally dried under vacuum and analyzed. The final catalyst component showed a particle size of 67.3 μm, a surface area (BET) of 284 m²/g, and a porosity (BET) of 0.213 cm³/g.

In terms of catalyst composition, the amount of Ti was 4.2% wt and the amount of 9,9-bis(methoxymethyl) fluorene was 16.8%. wt.

### Polymerization (Transition Homo-Raco)

A first propylene homopolymer with the features, and under polymerization conditions, reported in Table 1, was prepared.

TABLE 1

| | | |
|---|---|---|
| TEAL/CATALYST | wt ratio | 6 |
| TEAL/DONOR | wt ratio | 8 |
| PREPOLY | ° C./barg | |
| T | | 30 |
| H₂/C₃⁻ | ° C. | — |
| POLYMERIZATION | | |
| T-P | ° C.-barg | 75-28 |
| Mileage | kg/g | 60 |
| H₂/C₃⁻ | mol/mol | 0.0075 |
| POLYMER ANALYSIS | | |
| MFR | dg/min | 6.6 |
| C₂⁻ | % wt | — |
| XS | % wt | 2.5 |
| PBD | kg/dm³ | 0.426 |
| P50 | μm | 2513 |
| <500 | % wt | 1.2-1.8 |

A transition to a propylene copolymer grade was started by introducing ethylene in the gaseous reactor mixture, thereby producing the copolymer having the reported features under the following reaction conditions as a steady state.

TABLE 2

| | | |
|---|---|---|
| TEAL/CATALYST | wt ratio | 6 |
| TEAL/DONOR | wt ratio | 8 |
| PREPOLY | ° C./barg | |
| T | | 30 |
| H₂/C₃⁻ | ° C. | — |
| POLYMERIZATION | | |
| T-P | ° C.-barg | 75-28 |
| Mileage | kg/g | 70 |
| H₂/C₃⁻ | mol/mol | 0.0070 |
| C₂/C₂⁻ + C₃⁻ | mol/mol | 0.018 |
| POLYMER ANALYSIS | | |
| MFR | dg/min | 6.8 |
| C₂⁻ | % wt | 1.8 |
| XS | % wt | 4.45 |
| PBD | kg/dm³ | 0.425 |
| P50 | μm | 2755 |
| <500 | % wt | 0.4 |

The transition time lasted about three hours. At the beginning of the transition, the delta temperature between reactor skin and interior at the downcomer bottom was 7.8° C. During transition, the delta temperature reached the value of 9.1° C., thereby providing the maximum difference of 1.3° C.

### Comparative Example 1

The same polymerization procedure and transition time were repeated with the difference that the catalyst used was prepared as follows.

### Catalyst Support Preparation

An initial amount of MgCl₂·2.8C₂H₅OH adduct was prepared according to the methodology described in Example 2 of Patent Cooperation Treaty Publication No. WO98/44009, but operating on larger scale.

The adduct was then thermally dealcoholated under increasing temperature nitrogen flow until the content of EtOH reached a chemical composition of 49.7% wt EtOH and 1.2% wt of water and a particle size D50 of 52.0 μm.

### Preparation of Final Catalyst Component

Into a 2.0 liter round bottom flask, equipped with mechanical stirrer, cooler and thermometer, 1.0 l of TiCl₄ were introduced at room temperature under nitrogen atmosphere. After cooling at 0° C., while stirring, 50 g of microspheroidal prepared as disclosed in the general procedure were introduced. The temperature was then raised from 0° C. up to 40° C. at a speed of 0.4° C./min. and an amount of 9,9-bis(methoxymethyl) fluorene, thereby providing a Mg/diether molar ratio of 5. Then the temperature was raised to 100° C. for 50 min. The treatment with TiCl₄ was repeated at 109° C. for 20 min and then 109° C. for 15 min. The solid was washed five times with anhydrous hexane (5×900 ml) at 50° C.

The solid was finally dried under vacuum and analyzed. The final catalyst component showed a particle size of 53.7.μm and a surface area (BET) of 65 m²/g.

In terms of catalyst composition, the amount of Ti was 4.3% wt and the amount of 9,9-bis(methoxymethyl) fluorene was 15.4%. wt.

### Polymerization (Transition Homo-Raco)

The same polymerization procedure and transition time of example 1 was carried out. At the beginning of the transition, the delta temperature between reactor skin and interior at the downcomer bottom was −1.3° C. During transition, the delta temperature reached the value of 6.4° C., thereby providing a maximum difference of 7.7° C.

### Example 2

### Preparation of Final Catalyst Component

Into a 2.0 liter round bottom flask, equipped with mechanical stirrer, cooler and thermometer, 1.0 l of TiCl₄ were introduced at room temperature under nitrogen atmosphere. After cooling at −5° C., while stirring, 45 g of microspheroidal adduct prepared as described in example 1 were introduced. The temperature was then raised from −5° C. up to 40° C. at a speed of 0.3° C./min. and an amount of 9,9-bis(methoxymethyl) fluorene, thereby providing a Mg/diether molar ratio of 8. Then the temperature was raised to 100° C. for 45 min. The treatment with TiCl₄ was repeated at 109° C. for 45 min in presence of an additional Mg/diether molar ratio of 21, and then a third time at 109° C. for 25 min. The solid was washed five times with anhydrous hexane (5×900 ml) at 50° C.

The solid was finally dried under vacuum and analyzed. The final catalyst component showed a particle size of 66.5 μm, a surface area (BET) of 174 m²/g, and a porosity (BET) of 0.183 cm³/g.

In terms of catalyst composition, the amount of Ti was 4.2% wt and the amount of 9,9-bis(methoxymethyl) fluorene was 17.9%. wt.

Polymerization (Transition Raco lowMFR-Raco High MFR)

A first propylene ethylene copolymer with the features, and under polymerization conditions, reported in Table 3 was prepared.

TABLE 3

| | | |
|---|---|---|
| TEAL/CATALYST | wt ratio | 6 |
| TEAL/DONOR | wt ratio | 8 |
| PREPOLY | ° C./barg | |
| T | | 30 |
| H₂/C₃⁻ | ° C. | — |
| POLYMERIZATION | | |
| T-P | ° C.-barg | 70-28 |
| Mileage | kg/g | 70 |
| H₂/C₃⁻ | mol/mol | 0.0057 |
| C₂/C₂⁻ + C₃⁻ | mol/mol | 0.025 |
| POLYMER ANALYSIS | | |
| MFR | dg/min | 3.2 |
| C₂⁻ | % wt | 2.8- |
| XS | % wt | 6.1 |
| PBD | kg/dm³ | 0.419 |
| P50 | μm | 2773 |
| <500 | % wt | 0.4-0.6 |

A transition to a propylene ethylene copolymer grade with higher melt flow rate was started by an increment of hydrogen feed in the gaseous reactor mixture, thereby producing the copolymer having the reported features under the following reaction conditions as a steady state.

TABLE 4

| | | |
|---|---|---|
| TEAL/CATALYST | wt ratio | 6 |
| TEAL/DONOR | wt ratio | 8 |
| PREPOLY | ° C./barg | |
| T | | 30 |
| H₂/C₃⁻ | ° C. | — |
| POLYMERIZATION | | |
| T-P | ° C.-barg | 75-28 |
| Downer velocity | m/s | 0.211 |
| Mileage | kg/g | 76 |
| H₂/C₃⁻ | mol/mol | 0.0304 |
| C₂/C₂⁻ + C₃⁻ | mol/mol | 0.025 |
| POLYMER ANALYSIS | | |
| MFR | dg/min | 42 |
| C₂⁻ | % wt | 3.2- |
| XS | % wt | 7.3 |
| PBD | kg/dm³ | 0.422 |
| P50 | μm | 2936 |
| <500 | % wt | 0.7-1.0 |

The transition time lasted about five hours. At the beginning of the transition, the delta temperature between reactor skin and interior at the downcomer bottom was 6.0° C. During transition, the delta temperature reached the value of 5.5° C., thereby providing the maximum difference of −0.5° C. The production of the copolymer grade was completed without observing reactor fouling.

### Comparative Example 2

The same polymerization procedure and transition conditions used in example 2 were replicated with the difference that the catalyst of comparative example 1 was used. At the beginning of the transition, the delta temperature between reactor skin and interior at the downcomer bottom was 2.0° C. At the end of transition, the delta temperature reached the value of 11.3° C., thereby providing the maximum difference of 9.3° C. Inspection of the reactor at the end of production revealed the presence of fouling.

What is claimed is:

1. A solid catalyst component for the polymerization of olefins, comprising:
Ti, Mg and an internal donor selected from 1,3-diethers,
wherein the solid catalyst component having
(i) an average particle size (D50) ranging from 55 to 80 μm and by
(ii)_a surface area (SA), determined with the BET method, such that the value of the formula SA×D50/100 is higher than 60.

2. The solid catalyst component according to claim 1, wherein the value of the formula SA×D50/100 is higher than 80.

3. The solid catalyst component according to claim 2, wherein the value of the formula SA×D50/100 is higher than 100.

4. The solid catalyst component according to claim 1, wherein the average particle size D50 ranging from 55 to 75 μm.

5. The solid catalyst component according to claim 1, having porosity (P), measured by the BET method, higher than 0.18 cm³/g.

6. The solid catalyst component according to claim 1, wherein the surface area (SA) ranges from 180 to 400 m²/g.

7. The solid catalyst component according to claim 6, wherein the surface area (SA) ranges from 200 to 350 m²/g.

8. The solid catalyst component according to claim 1, wherein the value of the formula SA×P is higher than 10.

9. The solid catalyst component according to claim 8, wherein the value of the formula SA×P is higher than 20.

10. The solid catalyst component according to claim 1, wherein the 1,3 diether has the formula 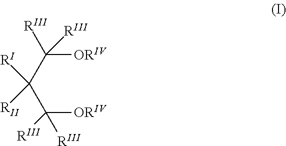
wherein R^{I} and R^{II} are the same or different and are hydrogen or linear or branched C₁-C₁₈ hydrocarbon groups; the R^{III} groups, equal or different from each other, are hydrogen or C₁-C₁₈ hydrocarbon groups; the R^{IV} groups equal or different from each other, have the same meaning of R^{III} except that R^{IV} groups are not hydrogen.

11. The solid catalyst component according to claim 9, wherein the 1,3-diethers have the formula (III): 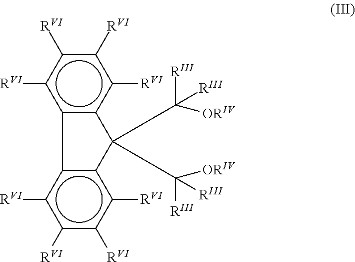
wherein the R^{III} and R^{IV} radicals have the same meaning defined in formula (I), R^{VI} radicals, equal or different, are hydrogen; halogens; C₁-C₂₀ alkyl radicals, linear or branched; C₃-C₂₀ cycloalkyl, C₆-C₂₀ aryl, C₇-C₂₀ alkylaryl, and C₇-C₂₀ aralkyl radicals, optionally containing one or more heteroatoms selected from the group consisting of N, O, S, P, Si and halogens, as substitutes for carbon or hydrogen atoms, or both.

12. A catalyst system for the polymerization of olefins CH₂═CHR, wherein R is hydrogen or a hydrocarbyl radical with 1-12 carbon atoms, comprising the product of the reaction between:
(i) the solid catalyst component according to claim 1,
(ii) an alkylaluminum compound and, optionally,
(iii) an external electron donor compound.

13. A catalyst system according to claim 12, wherein the external electron donor is selected from silicon compounds having formula Rₐ⁵R_{b}⁶Si(OR⁷)_{c}, where a and b are integer from 0 to 2, c is an integer from 1 to 3 and the sum (a+b+c) is 4; R⁵, R⁶, and R⁷, are alkyl, cycloalkyl or aryl radicals with 1-18 carbon atoms optionally containing heteroatoms selected from N, O, halogen and P.

14. A gas-phase process for the polymerization of olefins CH₂═CHR, wherein R is hydrogen or a C₁-C₁₂ hydrocarbyl group, carried out in the presence of the catalyst system according to claim 12.

15. The gas phase process according to claim 14, wherein
(i) the gas phase process is carried out in a reactor comprising a first interconnected polymerization zone and a second interconnected polymerization zone and
(ii) the polymer particles flow through the first polymerization zone (riser) under fast fluidization conditions, leave the first polymerization zone, enter the second polymerization zone (downcomer) through which the polymer particles flow in a densified form under the action of gravity, leave the second polymerization zone, and are reintroduced into the first polymerization zone, thereby establishing a circulation of polymer between the two polymerization zones.
